(19) United States
(12) Patent Application Publication
(10) Pub. No.: US 2023/0096320 A1
(43) Pub. Date: Mar. 30, 2023

(54) ALKALINE WATER ELECTROLYSIS VESSEL

(71) Applicant: TOKUYAMA CORPORATION, Shunan-shi, Yamaguchi (JP)

(72) Inventor: Yasuyuki TANAKA, Shunan-shi (JP)

(73) Assignee: TOKUYAMA CORPORATION, Shunan-shi, Yamaguchi (JP)

(21) Appl. No.: 17/798,913

(22) PCT Filed: Mar. 23, 2021
(86) PCT No.: PCT/JP2021/011900

§ 371 Date: Aug. 11, 2022

(30) Foreign Application Priority Data
Mar. 31, 2020 (JP) 2020-062486

(51) Int. Cl. C25B 9/23; C25B 1/04; C25B 1/34; C25B 9/60; C25B 11/031; C25B 15/04

(52) U.S. Cl. CPC C25B 9/23; C25B 1/04; C25B 1/34; C25B 9/60; C25B 11/031; C25B 15/04

(57) ABSTRACT

An alkaline water electrolysis vessel including: an anode-side frame body defining an anode chamber; a cathode-side frame body defining a cathode chamber; an ion-permeable separating membrane being arranged between the anode-side frame body and the cathode-side frame body, and separating the anode chamber and the cathode chamber; a gasket being sandwiched by the anode-side frame body and the cathode-side frame body to be held therebetween, and holding the periphery of the separating membrane; an anode being arranged in the anode chamber without being held by the gasket; a cathode being arranged in the cathode chamber without being held by the gasket; and an electroconductive first elastic body arranged in the anode chamber, wherein the anode is a flexible first porous plate; and the anode is arranged between the separating membrane and the first elastic body, and is pushed by the first elastic body toward the cathode.

### TECHNICAL FIELD

The present invention relates to an electrolysis vessel for alkaline water electrolysis.

### BACKGROUND ART

The alkaline water electrolysis method is known as a method of producing hydrogen gas and oxygen gas. In the alkaline water electrolysis method, hydrogen gas is generated at a cathode and oxygen gas is generated at an anode by electrolyzing water with a basic solution (alkaline water) as an electrolytic solution: in the basic solution, an alkali metal hydroxide (such as NaOH and KOH) dissolves. An electrolysis vessel including an anode chamber and a cathode chamber is known as an electrolysis vessel for alkaline water electrolysis: in the anode chamber, an anode is disposed, in the cathode chamber, a cathode is disposed, and the anode chamber and the cathode chamber are separated by an ion-permeable separating membrane. Further, for reducing energy loss, an electrolysis vessel having a zero-gap configuration (zero-gap electrolysis vessel) and including an anode and a cathode which are each held to be in direct contact with a separating membrane is proposed.

### CITATION LIST

### Patent Literature

Patent Literature 1: JP 2001-262387 A

Patent Literature 2: JP 2013-104090 A

Patent Literature 3: JP 2013-108150 A

Patent Literature 4: WO 2018/139616 A1

Patent Literature 5: JP 2015-117407 A

Patent Literature 6: WO 2013/191140 A1

Patent Literature 7: JP 4453973 B2

Patent Literature 8: JP 6093351 B2

Patent Literature 9: JP 2015-117417 A

Patent Literature 10: WO 2019/111832 A1

### SUMMARY OF INVENTION

### Technical Problem

FIG. 1 is a partial cross-sectional view schematically illustrating a conventional zero-gap alkaline water electrolysis vessel 900 according to one embodiment. The zero-gap electrolysis vessel 900 comprises: electrode chamber units 910, 910, . . . each including an electroconductive separating wall 911 that separates an anode chamber A and a cathode chamber C, and a flange part 912. Every two adjacent electrode chamber units 910, 910 comprise an ion-permeable separating membrane 920 arranged therebetween; gaskets 930, 930 which are arranged between the separating membrane 920 and the flange parts 912 of the electrode chamber units 910, and between which the periphery of the separating membrane 920 is sandwiched; a rigid anode 940 held by electroconductive ribs 913, 913, . . . that protrude from the separating wall 911 of one of the electrode chamber units; and a flexible cathode 970 held by a current collector 950 that is held by electroconductive ribs 914, 914, . . . that protrude from the separating wall 911 of the other electrode chamber unit, and an electroconductive elastic body 960 that is arranged in contact with the current collector 950. The periphery of the cathode 970 and the periphery of the electroconductive elastic body 960 are fixed to the periphery of the current collector 950. In the zero-gap electrolysis vessel 900, in every two adjacent electrode chamber units 910, 910, the electroconductive elastic body 960 pushes the flexible cathode 970 toward the separating membrane 920 and the anode 940; thereby, the separating membrane 920 is sandwiched between the adjacent cathode 970 and anode 940. As a result, the separating membrane 920 is in direct contact with the anode 940 and the cathode 970 (that is, there is a zero-gap), which reduces the solution resistance between the anode 940 and the cathode 970, and thus, reduces energy loss.

In the conventional zero-gap alkaline water electrolysis vessel 900, the electroconductive elastic bodies 960 push the flexible cathodes 970 toward the separating membranes 920 and the rigid anodes 940, the rigid anodes 940 are welded to the electroconductive ribs 913, and the electroconductive ribs 913 are welded to the separating walls 911. This structure can be considered to be reasonable in the process of alkaline water electrolysis in which it is often the case that the pressure on the cathode chamber side where hydrogen gas is generated is kept higher than that on the anode chamber side where oxygen gas is generated. That is, generally, an inexpensive porous membrane is used as the ion-permeable separating membrane 920 in an alkaline water electrolysis vessel instead of an expensive ion-exchange membrane that is used in an electrolysis vessel for alkali metal salts. The porous separating membrane 920 also has, unlike an ion-exchange membrane, gas permeability in some degree. Because of this, it is advantageous to carry out electrolysis with the pressure in the cathode chamber, where hydrogen gas is generated, kept higher than that in the anode chamber, where oxygen gas is generated, in view of improving the purity of hydrogen gas collected from the cathode chamber. When the pressure in the cathode chamber is higher than that in the anode chamber, the separating membrane 920 is pushed toward the anode 940 by the differential pressure between both the electrode chambers. In such a structure that the electroconductive elastic body 960 pushes the flexible cathode 970 toward the rigid anode 940 as in the alkaline water electrolysis vessel 900, the direction where the electroconductive elastic body 960 pushes the cathode 970 is the same as that of the force by which the differential pressure between both the electrode chambers pushes the separating membrane 920. Thus, such a structure allows a zero-gap state to be stably maintained even when the resilience of the electroconductive elastic body 960 is low. This can be also considered to be advantageous in view of lengthening the intervals for the renewal of the elastic body 960, and in view of reducing abrasion of the separating membrane 920 which is caused by a pressure fluctuation during the operation.

However, oxygen gas is generated at the anode 940 in the alkaline water electrolysis vessel, which, in combination with the fact that electrons flow out of the anode 940, puts the anode 940 under an oxidative condition. The anode 940 generally includes an electroconductive base material, and a catalyst supported on the surface of this base material. Catalysts and electroconductive base materials tend to ionize or oxidize at the anode 940 put under an oxidative condition as described above, which makes the catalyst easy to fall off the surface of the electrode. As a result, the anode 940 tends to reach its life span sooner than the cathode 970. The anode 940 having reached its life span is necessary to be replaced with a new anode. For replacing the anode 940 in the electrolysis vessel 900, it is necessary to (1) separate the anode 940 from the electroconductive ribs 913 mechanically (for example, by melt-cutting), (2) adjust the electroconductive ribs 913 and make the electroconductive ribs 913 the same height at their ends (for example, by grinding), and thereafter (3) welding the new anode 940 to the electroconductive ribs 913. It is difficult to carry out the work of replacing the anode 940 at a site where the electrolysis vessel is placed and operated because facilities especially for such replacement work are necessary. Thus, the electrode chamber unit 910 that includes the anode 940 having reached its life span is sent to a factory where the work of replacing the anode 940 can be carried out; and after the work of replacing the anode 940 has been carried out at this factory, the electrode chamber unit 910 after the work of replacing the anode 940 has been finished is sent back from the factory to the site where the electrolysis vessel is placed and operated as it is, or in a state where the elastic body 960 and the cathode 970 are further attached thereto. Like this, the work of renewing an anode for a conventional zero-gap alkaline water electrolysis vessel costs a lot.

Like this, a rigid anode is generally fixed to an electroconductive rib by welding or the like. Thus, the replacement of anodes requires some trouble and cost. The electrolysis vessel can comprise no electroconductive rib in view of easy attachment and detachment of anodes. The electroconductive rib however plays not only a role of electrically connecting an electrode and the separating wall, but also another important role of securing a space for an electrolyte and gas to flow in an electrode chamber. Particularly, in a zero-gap electrolysis vessel, the gas generated at an electrode cannot escape toward the separating membrane side of the electrode, and thus, escapes toward the separating wall side of the electrode. Providing a wide space in some degree which allows the gas generated at an electrode to escape on the back (that is, on the separating wall side) of the electrode (and, if there is, of an electroconductive elastic body) can shorten a time period when the gas generated at the electrode resides in the vicinity of the electrode, which thus can reduce the resistance of the gas, and reduce the electrolysis voltage. Therefore, it is important to provide the anode chamber with an electroconductive rib also in view of reducing energy loss.

An object of the present invention is to provide a zero-gap alkaline water electrolysis vessel that allows easy replacement of anodes particularly even when an electroconductive rib is provided in the anode chamber.

Solution to Problem

The present invention encompasses the following embodiments [1] to [9].

[1] An alkaline water electrolysis vessel comprising:

an anode-side frame body defining an anode chamber;

a cathode-side frame body defining a cathode chamber;

an ion-permeable separating membrane being arranged between the anode-side frame body and the cathode-side frame body, and separating the anode chamber and the cathode chamber;

a gasket being sandwiched by the anode-side frame body and the cathode-side frame body to be held therebetween, and holding a periphery of the separating membrane;

an anode being arranged in the anode chamber without being held by the gasket;

a cathode being arranged in the cathode chamber without being held by the gasket; and

an electroconductive first elastic body arranged in the anode chamber,

wherein the anode is a flexible first porous plate; and

the anode is arranged between the separating membrane and the first elastic body, and is pushed by the first elastic body toward the cathode.

[2] The electrolysis vessel according to [1],

the anode chamber comprising:
at least one first electroconductive rib protruding from an inner wall of the anode-side frame body; and
an electroconductive first current collector held by the first electroconductive rib,

the first current collector supporting the first elastic body.

[3] The electrolysis vessel according to [1] or [2], further comprising:

an electroconductive first rigid current collector being arranged in contact with the anode,

the first rigid current collector being arranged between the anode and the first elastic body,

the first rigid current collector supporting the anode.

[4] The electrolysis vessel according to any one of [1] to [3],

wherein the cathode is a rigid porous plate.

[5] The electrolysis vessel according to [4],

the cathode chamber comprising:
at least one second electroconductive rib protruding from an inner wall of the cathode-side frame body,

the second electroconductive rib holding the cathode.

[6] The electrolysis vessel according to any one of [1] to [3], further comprising:

an electroconductive second elastic body arranged in the cathode chamber,

wherein the cathode is a flexible second porous plate; and

the cathode is arranged between the separating membrane and the second elastic body, and is pushed by the second elastic body toward the anode.

[7] The electrolysis vessel according to [6],

the cathode chamber comprising:
at least one second electroconductive rib protruding from an inner wall of the cathode-side frame body; and
an electroconductive second current collector held by the second electroconductive rib,

the second current collector supporting the second elastic body.

[8] The electrolysis vessel according to [6] or [7], further comprising:

an electroconductive second rigid current collector arranged in contact with the cathode,

the second rigid current collector being arranged between the cathode and the second elastic body,

the second rigid current collector supporting the cathode.

[9] A method for replacement of an electrode of an alkaline water electrolysis vessel, the electrode being the anode of the alkaline water electrolysis vessel as defined in any one of [1] to [8], the method comprising:

separating the anode-side frame body from the gasket;

separating the separating membrane from the anode;

taking the anode out of the anode chamber; and

assembling the alkaline water electrolysis vessel with a new anode instead of the anode taken out of the anode chamber.

### Advantageous Effects of Invention

According to the alkaline water electrolysis vessel of the present invention, the zero-gap configuration is realized by pushing the flexible anode toward the cathode by the electroconductive elastic body. Thus, the alkaline water electrolysis vessel according to the present invention allows easy replacement of the anode particularly even when the electroconductive rib is provided in the anode chamber.

### BRIEF DESCRIPTION OF DRAWINGS

FIG. 1 is a cross-sectional view schematically illustrating a conventional zero-gap alkaline water electrolysis vessel 900 according to one embodiment;

FIG. 2 is a cross-sectional view schematically illustrating an alkaline water electrolysis vessel 100 according to one embodiment of the present invention;

FIG. 3 is a cross-sectional view schematically illustrating an alkaline water electrolysis vessel 200 according to another embodiment of the present invention;

FIG. 4 is a cross-sectional view schematically illustrating an alkaline water electrolysis vessel 300 according to another embodiment of the present invention;

FIG. 5 is a cross-sectional view schematically illustrating an alkaline water electrolysis vessel 400 according to another embodiment of the present invention; and

FIG. 6 is a cross-sectional view schematically illustrating an alkaline water electrolysis vessel 500 according to another embodiment of the present invention.

### DESCRIPTION OF EMBODIMENTS

Hereinafter embodiments according to the present invention will be described with reference to the drawings. The present invention is not limited to these embodiments. The dimensions in the drawings do not always represent exact dimensions. Some reference signs may be omitted in the drawings. In the present description, the expression “A to B” concerning numeral values A and B shall mean “no less than A and no more than B” unless otherwise specified. In such an expression, if a unit is added only to the numeral value B, this unit shall be applied to the numeral value A as well. A word “or” shall mean a logical sum unless otherwise specified. The expression “E₁ and/or E₂” concerning elements E₁ and E₂ shall mean “E₁, or E₂, or the combination thereof”; and the expression “E₁, . . ., EN-1, and/or EN” concerning elements E₁, . . . , E_{N}(N is an integer of 3 or more) shall mean “E₁, . . . , E_{N-1}, or E_{N}, or any combination thereof”.

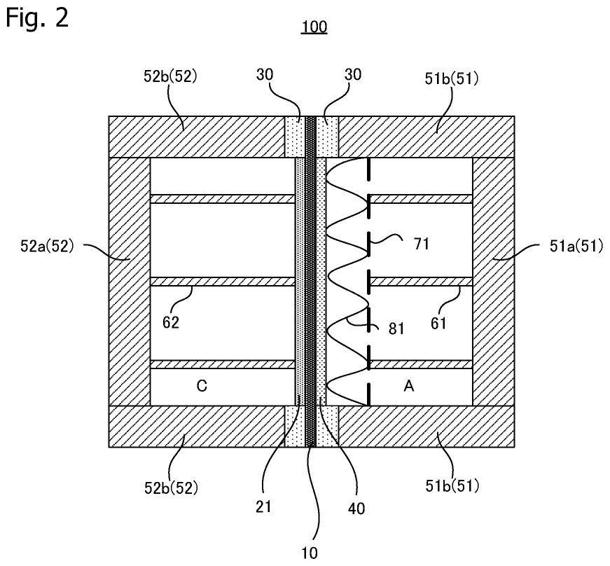

FIG. 2 is a cross-sectional view schematically illustrating an alkaline water electrolysis vessel 100 according to one embodiment (hereinafter may be referred to as “electrolysis vessel 100”). As shown in FIG. 2, the electrolysis vessel 100 comprises: an electroconductive anode-side frame body 51 defining an anode chamber A; an electroconductive cathode-side frame body 52 defining a cathode chamber C; an ion-permeable separating membrane 10 being arranged between the anode-side frame body 51 and the cathode-side frame body 52, and separating the anode chamber A and the cathode chamber C; gaskets 30, 30 (hereinafter may be simply referred to as “gaskets 30”) being sandwiched by the anode-side frame body 51 and the cathode-side frame body 52 to be held therebetween, and holding the periphery of the separating membrane 10; an anode 40 being arranged in the anode chamber A without being held by any of the gaskets 30; and a cathode 21 being arranged in the cathode chamber C without being held by any of the gaskets 30. In the electrolysis vessel 100, the anode 40 is a flexible porous plate (first porous plate), and the cathode 21 is a rigid porous plate (second porous plate). The electrolysis vessel 100 also comprises: at least one electroconductive rib(s) (first electroconductive ribs) 61, 61, . . . (hereinafter may be referred to as “electroconductive ribs 61”) protruding from the inner wall of the anode-side frame body 51; a current collector (first current collector) 71 held by the electroconductive ribs 61; and an electroconductive elastic body (first elastic body) 81 held by the current collector 71. The anode 40 is pushed by the elastic body 81 toward the cathode 21. The electrolysis vessel 100 further comprises: at least one electroconductive rib(s) (second electroconductive ribs) 62, 62, . . . (hereinafter may be referred to as “electroconductive ribs 62”) protruding from the inner wall of the cathode-side frame body 52. The cathode 21 is held by the electroconductive ribs 62.

As the anode-side frame body 51 and the cathode-side frame body 52, any known frame bodies used for an alkaline water electrolysis vessel may be used without particular limitations as long as the anode chamber A and the cathode chamber C can be each defined thereby. The anode-side frame body 51 has an electroconductive separating wall 51a, and a flange part 51b uniting with the entire periphery of the separating wall 51a with watertightness. Likewise, the cathode-side frame body 52 has an electroconductive separating wall 52a, and a flange part 52b uniting with the entire periphery of the separating wall 52a with watertightness. The separating walls 51a and 52a separate and electrically connect in series adjacent electrolytic cells, respectively. The flange part 51b, together with the separating wall 51a, the separating membrane 10 and one of the gaskets 30, defines the anode chamber A. The flange part 52b, together with the separating wall 52a, the separating membrane 10 and the other gasket 30, defines the cathode chamber C. The flange parts 51b and 52b have shapes corresponding to the gaskets 30. That is, when the gaskets 30 are sandwiched between and held by the anode-side frame body 51 and the cathode-side frame body 52, the flange part 51b of the anode-side frame body 51 and the flange part 52b of the cathode-side frame body 52 are in contact with the gaskets 30, 30, respectively, without any gap. The flange part 51b is provided with an anolyte supply flow path adapted to supply an anolyte to the anode chamber A, and an anolyte collection flow path adapted to collect, from the anode chamber A, the anolyte and gas generated at the anode, which are not shown in FIG. 2. The flange part 52b is provided with a catholyte supply flow path adapted to supply a catholyte to the cathode chamber C, and a catholyte collection flow path adapted to collect, from the cathode chamber C, the catholyte and gas generated at the cathode. As the material of the separating walls 51a and 52a, any alkali-resistant rigid electroconductive material may be used without particular limitations. Examples of such a material include simple metals such as nickel and iron; stainless steel such as SUS304, SUS310, SUS310S, SUS316 and SUS316L; and metallic materials obtained by nickeling any of them. As the material of the flange parts 51b and 52b, any alkali-resistant rigid material may be used without particular limitations. Examples of such a material include simple metals such as nickel and iron; stainless steel such as SUS304, SUS310, SUS310S, SUS316 and SUS316L; metallic materials obtained by nickeling any of them; and non-metallic materials such as reinforced plastics. The separating wall 51a and the flange part 51b of the anode-side frame body 51 may be joined to each other by welding, adhesion, or the like, and may be formed of the same material into one body. Likewise, the separating wall 52a and the flange part 52b of the cathode-side frame body 52 may be joined to each other by welding, adhesion, or the like, and may be formed of the same material into one body. FIG. 2 shows a single electrolytic cell (electrolysis vessel 100) only. However, the flange part 51b of the anode-side frame body 51 may extend to the opposite side of the separating wall 51a (right side of the sheet of FIG. 2) as well, to define, together with the separating wall 51a, the cathode chamber of the neighboring electrolytic cell, and the flange part 52b of the cathode-side frame body 52 may extend to the opposite side of the separating wall 52a (left side of the sheet of FIG. 2) as well, to define, together with the separating wall 52a, the anode chamber of the neighboring electrolytic cell.

As the separating membrane 10, any known ion-permeable separating membrane used for a zero-gap electrolysis vessel for alkaline water electrolysis may be used without particular limitations. Desirably, the separating membrane 10 has low gas permeability, low electric conductivity, and high strength. Examples of the separating membrane 10 include porous separating membranes such as a porous membrane formed of asbestos and/or modified asbestos, a porous separating membrane using a polysulfone-based polymer, a cloth using a polyphenylene sulfide fiber, a fluorinated porous membrane, and a porous membrane using a hybrid material that includes both inorganic and organic materials. Other than these porous separating membranes, an ion-exchange membrane such as a fluorinated ion-exchange membrane can be used as the separating membrane 10.

Any electrical insulating gaskets used for an electrolysis vessel for alkaline water electrolysis may be used as the gaskets 30 without particular limitations. FIG. 2 shows a cross section of the gaskets 30. Each of the gaskets 30 has a flat shape. The periphery of the separating membrane 10 is sandwiched between and held by the gaskets 30, and at the same time the gaskets 30 are sandwiched between and held by the flange part 51b of the anode-side frame body 51 and the flange part 52b of the cathode-side frame body 52. The gaskets 30 are preferably formed of an alkali-resistant elastomer. Examples of the material of the gaskets 30 include elastomers such as natural rubber (NR), styrene-butadiene rubber (SBR), polychloroprene (CR), butadiene rubber (BR), acrylonitrile-butadiene rubber (NBR), silicone rubber (SR), ethylene propylene rubber (EPT), ethylene propylene diene monomer rubber (EPDM), fluororubber (FR), isobutylene isoprene rubber (IIR), urethane rubber (UR), and chlorosulfonated polyethylene rubber (CSM). When a gasket material that is not alkali-resistant is used, a layer of an alkali-resistant material may be provided over the surface of the gasket material by coating or the like.

As the first electroconductive ribs 61 and the second electroconductive ribs 62, any known electroconductive ribs used for an alkaline water electrolysis vessel may be used without particular limitations. In the electrolysis vessel 100, the first electroconductive ribs 61 protrude from the separating wall 51a of the anode-side frame body 51, and the second electroconductive ribs 62 protrude from the separating wall 52a of the cathode-side frame body 52. The shape, the number, and the arrangement of the first electroconductive ribs 61 are not particularly limited as long as the first current collector 71 can be fixed to and held with respect to the anode-side frame body 51 by means of the first electroconductive ribs 61. The shape, the number, and the arrangement of the second electroconductive ribs 62 are not particularly limited either as long as the cathode 21 can be fixed to and held with respect to the cathode-side frame body 52 by means of the second electroconductive ribs 62. As the material of the first electroconductive ribs 61 and the second electroconductive ribs 62, any alkali-resistant rigid electroconductive material may be used without particular limitations. Examples of such a material include materials such as simple metals such as nickel and iron; stainless steel such as SUS304, SUS310, SUS310S, SUS316 and SUS316L; and metals obtained by nickeling any of them.

As the current collector (first current collector) 71, any known current collector used for an alkaline water electrolysis vessel may be used without particular limitations. For example, an expanded metal, punching metal, or net which is made from an alkali-resistant rigid electroconductive material may be preferably used. Examples of the material of the current collector 71 include simple metals such as nickel and iron; stainless steel such as SUS304, SUS310, SUS310S, SUS316 and SUS316L; and metals obtained by nickeling any of them. For holding the current collector 71 by means of the electroconductive ribs 61, any known means such as welding and pinning may be employed without particular limitations.

As the elastic body (first elastic body) 81, any known electroconductive elastic body used for an alkaline water electrolysis vessel may be used without particular limitations. For example, an elastic mat, a coil spring, a leaf spring, or the like that is made of an aggregate of a metal wire of an alkali-resistant electroconductive material may be preferably used. Examples of the material of the elastic body 81 include simple metals such as nickel and iron; stainless steel such as SUS304, SUS310, SUS310S, SUS316 and SUS316L; and metals obtained by nickeling any of them. For holding the elastic body 81 by the current collector 71, any known means such as welding and pinning may be employed without particular limitations.

The anode 40 is an anode for generating oxygen. Generally, the anode 40 includes an electroconductive base material, and a catalyst layer covering the surface of the base material. The catalyst layer is preferably porous. As the electroconductive base material of the anode 40, for example, ferronickel, vanadium, molybdenum, copper, silver, manganese, a platinum group metal, graphite, or chromium, or any combination thereof may be used. In the anode 40, an electroconductive base material formed of nickel may be preferably used. The catalyst layer includes nickel as an element. The catalyst layer preferably includes nickel oxide, metallic nickel or nickel hydroxide, or any combination thereof, and may include an alloy of nickel and at least another metal. The catalyst layer is especially preferably formed of metallic nickel. The catalyst layer may further include chromium, molybdenum, cobalt, tantalum, zirconium, aluminum, zinc, a platinum group metal, or a rare earth element, or any combination thereof. Rhodium, palladium, iridium, or ruthenium, or any combination thereof may be further supported on the surface of the catalyst layer as an additional catalyst.

The anode 40 is a flexible porous plate (first porous plate). As the anode 40 of a flexible porous plate, a porous plate including a flexible electroconductive base material (such as a wire net woven (or knitted) with a metal wire, and a thin punching metal) and the above-described catalyst layer may be used. The opening area of one pore of the anode 40 of a flexible porous plate is preferably 0.05 to 2.0 mm², and more preferably 0.1 to 0.5 mm². The ratio of the pore opening area to the area of a current-carrying cross section of the anode 40 of a flexible porous plate is preferably no less than 20%, and more preferably 20 to 50%. The bending flexibility of the anode 40 of a flexible porous plate is preferably no less than 0.05 mm/g, and more preferably 0.1 to 0.8 mm/g. The bending flexibility in the present description is a value obtained by dividing a deflection (mm) of a sample of 10 mm square at one side (end of the sample) by a certain load (g) when another side of the sample which is opposite to the one side is horizontally fixed and the load is downwardly applied to the one side. That is, the bending flexibility is a parameter showing characteristics inverse to bending rigidity. For example, the bending flexibility may be adjusted by the material and thickness of the porous plate, and by the way of weaving (or knitting) a metal wire constituting a wire net when the wire net is used.

The periphery of the anode 40 is held by the current collector 71, the elastic body 81, and/or the flange part 51b of the anode-side frame body 51. For holding the periphery of the anode 40 by the current collector 71, the elastic body 81, and/or the flange part 51b of the anode-side frame body 51, any known means such as welding, pinning, bolting, and turning in over the current collector 71 (that is, hanging the anode 40 on the periphery of the current collector 71 at a valley part of the anode 40 which is formed by turning in the periphery of the anode 40) may be employed without particular limitations.

The cathode 21 is a cathode for generating hydrogen. Generally, the cathode 21 includes an electroconductive base material, and a catalyst layer covering the surface of the base material. As the electroconductive base material of the cathode 21, for example, nickel, a nickel alloy, stainless steel, mild steel, a nickel alloy, nickeled stainless steel, or nickeled mild steel may be preferably used. As the catalyst layer of the cathode 21, a coating formed of a noble metal oxide, nickel, cobalt, molybdenum, or manganese, or an oxide or a noble metal oxide thereof may be preferably used.

The cathode 21 is a rigid porous plate. As the cathode 21 of a rigid porous plate, a porous plate including a rigid electroconductive base material (such as an expanded metal) and the above-described catalyst layer may be used. For holding the cathode 21 by the electroconductive ribs 62, any known means such as welding, pinning, and bolting may be employed without particular limitations.

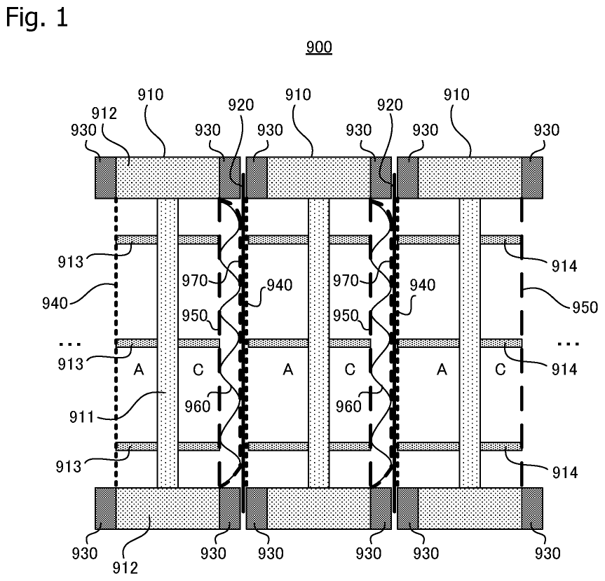

In the electrolysis vessel 100, the anode 40 is arranged between the separating membrane 10 and the first elastic body 81, and pushed by the first elastic body 81 toward the cathode 21; thereby, the zero-gap configuration is realized. In the electrolysis vessel 100, the work of replacing the anode 40 that has reached its life span with a new anode 40 comprises: (1) separating the anode-side frame body 51 from the gasket 30; (2) separating the separating membrane 10 from the anode 40; (3) taking the anode 40 out of the anode chamber A; and (4) assembling the electrolysis vessel 100 with the new anode 40 instead of the taken-out anode 40. In the electrolysis vessel 100, it is easy to take the anode 40 out in the (3), and to assemble with the new anode 40 in the (4). Since the position of the anode 40 is automatically adjusted by the first elastic body 81 in the assembled electrolysis vessel 100, complicated work as in a conventional zero-gab alkaline water electrolysis vessel (such as the work of adjusting the electroconductive ribs 913 and make the electroconductive ribs 913 the same height at their ends by griding or the like (see FIG. 1)) is not necessary for assembling with the new anode 40. Thus, the electrolysis vessel 100 allows easy replacement of the anode 40.

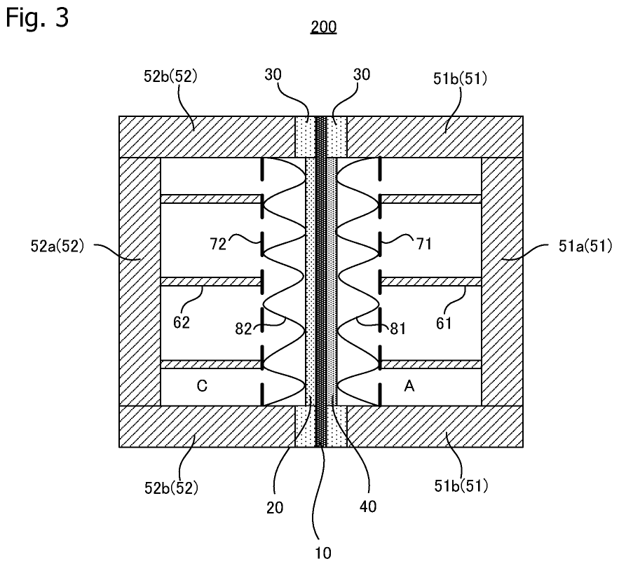

The alkaline water electrolysis vessel 100 comprising the cathode 21 of a rigid porous plate, which is held by the electroconductive ribs 62, has been described above concerning the present invention as an example. The present invention is not limited to this embodiment. For example, the alkaline water electrolysis vessel may comprise a cathode of a rigid porous plate which is pushed by an electroconductive second elastic body toward the anode. FIG. 3 is a cross-sectional view schematically illustrating an alkaline water electrolysis vessel 200 according to such another embodiment (hereinafter may be referred to as “electrolysis element 200”). In FIG. 3, the elements already shown in FIG. 2 are given the same reference signs as in FIG. 2, and the description thereof may be omitted. As shown in FIG. 3, the electrolysis vessel 200 comprises: the electroconductive anode-side frame body 51 defining the anode chamber A; the electroconductive cathode-side frame body 52 defining the cathode chamber C; the ion-permeable separating membrane 10 being arranged between the anode-side frame body 51 and the cathode-side frame body 52, and separating the anode chamber A and the cathode chamber C; the gaskets 30, 30 being sandwiched by the anode-side frame body 51 and the cathode-side frame body 52 to be held therebetween, and holding the periphery of the separating membrane 10; the anode 40 being arranged in the anode chamber A without being held by any of the gaskets 30; and a cathode 20 being arranged in the cathode chamber C without being held by any of the gaskets 30. In the electrolysis vessel 200, the anode 40 is a flexible first porous plate, and the cathode 20 is a flexible second porous plate. The electrolysis vessel 200 also comprises: said at least one electroconductive rib(s) (first electroconductive ribs) 61 protruding from the inner wall of the anode-side frame body 51; the current collector (first current collector) 71 held by the electroconductive ribs 61; and the electroconductive elastic body (first elastic body) 81 held by the current collector 71. The anode 40 is pushed by the elastic body 81 toward the cathode 20. The electrolysis vessel 200 also comprises: the electroconductive ribs (second electroconductive ribs) 62 protruding from the inner wall of the cathode-side frame body 52, a current collector (second current collector) 72 held by the electroconductive ribs 62; and an electroconductive elastic body (second elastic body) 82 held by the current collector 72. The cathode 20 is pushed by the elastic body 82 toward the anode 40.

In the electrolysis vessel 200, the same electroconductive ribs as the second electroconductive ribs 62 described above concerning the electrolysis vessel 100 (FIG. 2) may be used as the second electroconductive ribs 62. In the electrolysis vessel 200, the second electroconductive ribs 62 protrude from the separating wall 52a of the cathode-side frame body. The shape, the number, and the arrangement of the second electroconductive ribs 62 are not particularly limited as long as the second current collector 72 can be fixed to and held with respect to the cathode-side frame body 52 by means of the second electroconductive ribs 62.

In the electrolysis vessel 200, the periphery of the anode 40 is held by the current collector 71, the elastic body 81, and/or the flange part 51b of the anode-side frame body 51. For holding the periphery of the anode 40 by the current collector 71, the elastic body 81, and/or the flange part 51b of the anode-side frame body 51, any known means such as welding, pinning, bolting, and turning in over the current collector 71 (that is, hanging the anode 40 on the periphery of the current collector 71 at a valley part of the anode 40 which is formed by turning in the periphery of the anode 40) may be employed without particular limitations.

The cathode 20 is different from the cathode 21 (see FIG. 2) in being a flexible porous plate (second porous plate). As the cathode 20 of a flexible porous plate, a porous plate including a flexible electroconductive base material (such as a wire net woven (or knitted) with a metal wire, and a thin punching metal) and the above-described catalyst layer may be used. The opening area of one pore of the cathode 20 of a flexible porous plate is preferably 0.05 to 2.0 mm², and more preferably 0.1 to 0.5 mm². The ratio of the pore opening area to the area of a current-carrying cross section of the cathode 20 of a flexible porous plate is preferably no less than 20%, and more preferably 20 to 50%. The bending flexibility of the cathode 20 of a flexible porous plate is preferably no less than 0.05 mm/g, and more preferably 0.1 to 0.8 mm/g.

In the electrolysis vessel 200, the periphery of the cathode 20 is held by the current collector 72, the elastic body 82, and/or the flange part 52b of the cathode-side frame body 52. For holding the periphery of the cathode 20 by the current collector 72, the elastic body 82, and/or the flange part 52b of the cathode-side frame body 52, any known means such as welding, pinning, bolting, and turning in over the current collector 72 (that is, hanging the cathode 20 on the periphery of the current collector 72 at a valley part of the cathode 20 which is formed by turning in the periphery of the cathode 20) may be employed without particular limitations.

As the current collector (second current collector) 72, any known current collector used for an alkaline water electrolysis vessel may be used without particular limitations. For example, an expanded metal or punching metal made from an alkali-resistant rigid electroconductive material may be preferably used. Examples of the material of the current collector 72 include simple metals such as nickel and iron; stainless steel such as SUS304, SUS310, SUS310S, SUS316 and SUS316L; and metals obtained by nickeling any of them. For holding the current collector 72 by means of the electroconductive ribs 62, any known means such as welding and pinning may be employed without particular limitations.

As the elastic body (second elastic body) 82, any known electroconductive elastic body used for an alkaline water electrolysis vessel may be used without particular limitations. For example, an elastic mat, a coil spring, a leaf spring, or the like that is made of an aggregate of a metal wire of an alkali-resistant electroconductive material may be preferably used. Examples of the material of the elastic body 82 include simple metals such as nickel and iron; stainless steel such as SUS304, SUS310, SUS310S, SUS316 and SUS316L; and metals obtained by nickeling any of them. For holding the elastic body 82 by the current collector 72, any known means such as welding, pinning, and bolting may be employed without particular limitations.

In the electrolysis vessel 200, the anode 40 is arranged between the separating membrane 10 and the first elastic body 81, and pushed by the first elastic body 81 toward the cathode 20; and the cathode 20 is arranged between the separating membrane 10 and the second elastic body 82, and pushed by the second elastic body 82 toward the anode 40; thereby, the zero-gap configuration is realized. In the electrolysis vessel 200, the work of replacing the anode 40 that has reached its life span with the new anode 40 comprises: (1) separating the anode-side frame body 51 from the gasket 30; (2) separating the separating membrane 10 from the anode 40; (3) taking the anode 40 out of the anode chamber A; and (4) assembling the electrolysis vessel 200 with the new anode 40 instead of the taken-out anode 40. In the electrolysis vessel 200, it is easy to take the anode 40 out in the (3), and to assemble with the new anode 40 in the (4). Since the positions of the anode 40 and the cathode 20 are automatically adjusted by the first elastic body 81 and the second elastic body 82 in the assembled electrolysis vessel 200, complicated work as in a conventional zero-gab alkaline water electrolysis vessel (such as the work of adjusting the electroconductive ribs 913 and make the electroconductive ribs 913 the same height at their ends by griding or the like (see FIG. 1)) is not necessary for assembling with the new anode 40. Thus, the electrolysis vessel 200 also allows easy replacement of the anode 40.

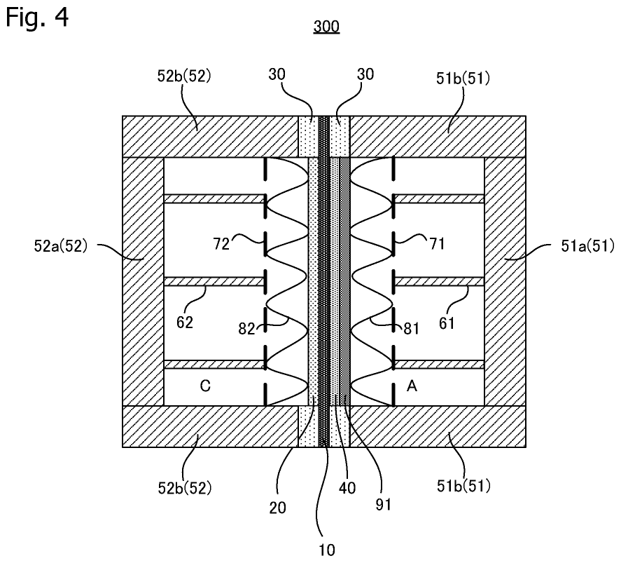

The alkaline water electrolysis vessel 100 or 200 comprising the anode 40 and the first elastic body 81, which are in direct contact with each other, the first elastic body 81 directly pushing the anode 40 toward the cathode (20 or 21) has been described above concerning the present invention as an example. The present invention is not limited to this embodiment. For example, the alkaline water electrolysis vessel may further comprise an electroconductive rigid current collector arranged between the anode and the first elastic body. FIG. 4 is a cross-sectional view schematically illustrating an alkaline water electrolysis vessel 300 according to such another embodiment (hereinafter may be referred to as “electrolysis element 300”). In FIG. 4, the elements already shown in FIGS. 2 to 3 are given the same reference signs as in FIGS. 2 to 3, and the description thereof may be omitted. As shown in FIG. 4, the electrolysis vessel 300 comprises: the electroconductive anode-side frame body 51 defining the anode chamber A; the electroconductive cathode-side frame body 52 defining the cathode chamber C; the ion-permeable separating membrane 10 being arranged between the anode-side frame body 51 and the cathode-side frame body 52, and separating the anode chamber A and the cathode chamber C; the gaskets 30, 30 being sandwiched by the anode-side frame body 51 and the cathode-side frame body 52 to be held therebetween, and holding the periphery of the separating membrane 10; the anode 40 being arranged in the anode chamber A without being held by any of the gaskets 30; and the cathode 20 being arranged in the cathode chamber C without being held by any of the gaskets 30. In the electrolysis vessel 300, the anode 40 is a flexible first porous plate, and the cathode 20 is a flexible second porous plate. The electrolysis vessel 300 also comprises: said at least one electroconductive rib(s) (first electroconductive ribs) 61 protruding from the inner wall of the anode-side frame body 51; the current collector (first current collector) 71 held by the electroconductive ribs 61; the electroconductive elastic body (first elastic body) 81 held by the current collector 71; and an electroconductive rigid current collector 91 arranged between the elastic body 81 and the anode 40. The anode 40 is pushed by the elastic body 81 with the rigid current collector 91 therebetween toward the cathode 20. That is, in the electrolysis vessel 300, the rigid current collector 91 is arranged in such a manner that the anode 40 is sandwiched between the rigid current collector 91 and the separating membrane 10, and the anode 40 is supported by the rigid current collector 91. The electrolysis vessel 300 also comprises: said at least one electroconductive rib(s) (second electroconductive ribs) 62 protruding from the inner wall of the cathode-side frame body 52, the current collector (second current collector) 72 held by the electroconductive ribs 62; and the electroconductive elastic body (second elastic body) 82 held by the current collector 72. The cathode 20 is pushed by the elastic body 82 toward the anode 40.

An electroconductive rigid current collector may be used as the rigid current collector 91. For example, an expanded metal or punching metal made from an alkali-resistant rigid electroconductive material may be preferably used. Examples of the material of the rigid current collector 91 include simple metals such as nickel and iron; stainless steel such as SUS304, SUS310, SUS310S, SUS316 and SUS316L; and metals obtained by nickeling any of them. The rigid current collector 91 may be, but is not necessary to be held by the elastic body 81. For holding the rigid current collector 91 by the elastic body 81, any known means such as welding, pinning, and bolting may be employed without particular limitations.

In the electrolysis vessel 300, the periphery of the anode 40 is held by the rigid current collector 91, the current collector 71, the elastic body 81, and/or the flange part 51b of the anode-side frame body 51, and is preferably held by the rigid current collector 91. For holding the periphery of the anode 40 by the rigid current collector 91, the current collector 71, the elastic body 81, and/or the flange part 51b of the anode-side frame body 51, any known means such as welding, pinning, bolting, and turning in over the rigid current collector 91 or the current collector 71 (that is, hanging the anode 40 on the periphery of the rigid current collector 91 or the periphery of the current collector 71 at a valley part of the anode 40 which is formed by turning in the periphery of the anode 40) may be employed without particular limitations.

In the electrolysis vessel 300, the periphery of the cathode 20 is held by the current collector 72, the elastic body 82, and/or the flange part 52b of the cathode-side frame body 52. For holding the periphery of the cathode 20 by the current collector 72, the elastic body 82, and/or the flange part 52b of the cathode-side frame body 52, any known means such as welding, pinning, bolting, and turning in over the current collector 72 (that is, hanging the cathode 20 on the periphery of the current collector 72 at a valley part of the cathode 20 which is formed by turning in the periphery of the cathode 20) may be employed without particular limitations.

In the electrolysis vessel 300, the separating membrane 10, the anode 40, the rigid current collector 91, and the first elastic body 81 are arranged in this order (that is, the anode 40 is arranged between the separating membrane 10 and the first elastic body 81; and the rigid current collector 91 is arranged between the anode 40 and the first elastic body 81), and the anode 40 is pushed by the first elastic body 81 with the rigid current collector 91 therebetween toward the cathode 20 (that is, toward the separating membrane 10); and the separating membrane 10, the cathode 20, and the second elastic body 82 are arranged in this order (that is, the cathode 20 is arranged between the separating membrane 10 and the second elastic body 82), and the cathode 20 is pushed by the second elastic body 82 toward the anode 40 (that is, toward the separating membrane 10); thereby, the zero-gap configuration is realized. In the electrolysis vessel 300, the work of replacing the anode 40 that has reached its life span with the new anode 40 comprises: (1) separating the anode-side frame body 51 from the gasket 30; (2) separating the separating membrane 10 from the anode 40; (3) taking the anode 40 out of the anode chamber A; and (4) assembling the electrolysis vessel 300 with the new anode 40 instead of the taken-out anode 40. In the electrolysis vessel 300, it is easy to take the anode 40 out in the (3), and to assemble with the new anode 40 in the (4). In particular, when the periphery of the anode 40 is held by the rigid current collector 91, it is enough for taking out the anode 40 to dissolve the connection of the anode 40 and the rigid current collector 91; and it is enough for assembling with the anode 40 to fix the anode 40 to the rigid current collector 91. Since the positions of the anode 40 and the cathode 20 are automatically adjusted by the first elastic body 81 and the second elastic body 82 in the assembled electrolysis vessel 300, complicated work as in a conventional zero-gab alkaline water electrolysis vessel (such as the work of adjusting the electroconductive ribs 913 and make the electroconductive ribs 913 the same height at their ends by griding or the like (see FIG. 1)) is not necessary for assembling with the new anode 40. Thus, the electrolysis vessel 300 also allows easy replacement of the anode 40. The electrolysis vessel 300 comprises the rigid current collector 91 between the anode 40 and the first elastic body 81, which can cause the pressure at which the anode 40 and the cathode 20 are pushed toward the separating membrane 10 to be more uniform over the entire faces of both the electrodes, and thus, can cause the current density to be more uniform. The electrolysis vessel 300 comprises the rigid current collector 91 between the anode 40 and the first elastic body 81, and thereby, can reduce deformation and abrasion of the separating membrane 10 which are caused by a pressure fluctuation in electrode chambers.

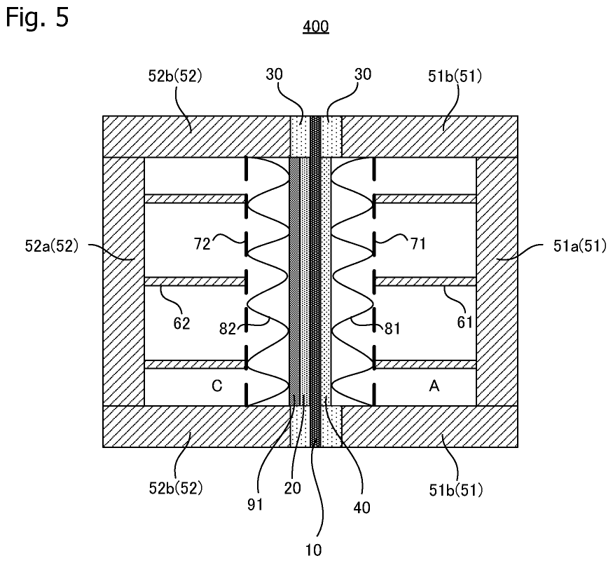

The alkaline water electrolysis vessel 300 wherein the electroconductive elastic body 81 pushes the anode 40 with the rigid current collector 91 therebetween toward the cathode 20 has been described above concerning the present invention as an example. The present invention is not limited to this embodiment. For example, in the alkaline water electrolysis vessel, an electroconductive elastic body may push the cathode with a rigid current collector therebetween toward the anode. FIG. 5 is a cross-sectional view schematically illustrating an alkaline water electrolysis vessel 400 according to such another embodiment (hereinafter may be referred to as “electrolysis element 400”). In FIG. 5, the elements already shown in FIGS. 2 to 4 are given the same reference signs as in FIGS. 2 to 4, and the description thereof may be omitted. As shown in FIG. 5, the electrolysis vessel 400 comprises: the electroconductive anode-side frame body 51 defining the anode chamber A; the electroconductive cathode-side frame body 52 defining the cathode chamber C; the ion-permeable separating membrane 10 being arranged between the anode-side frame body 51 and the cathode-side frame body 52, and separating the anode chamber A and the cathode chamber C; the gaskets 30, 30 being sandwiched by the anode-side frame body 51 and the cathode-side frame body 52 to be held therebetween, and holding the periphery of the separating membrane 10; the anode 40 being arranged in the anode chamber A without being held by any of the gaskets 30; and the cathode 20 being arranged in the cathode chamber C without being held by any of the gaskets 30. In the electrolysis vessel 400, the anode 40 is a flexible first porous plate. In the electrolysis vessel 400, the cathode 20 may be a rigid porous plate, and may be a flexible porous plate (second porous plate), and is preferably a flexible porous plate. The electrolysis vessel 400 comprises: said at least one electroconductive rib(s) (first electroconductive ribs) 61 protruding from the inner wall of the anode-side frame body 51; the current collector (first current collector) 71 held by the electroconductive ribs 61; and the electroconductive elastic body (first elastic body) 81 held by the current collector 71. The anode 40 is pushed by the elastic body 81 toward the cathode 20. The electrolysis vessel 400 also comprises: said at least one electroconductive rib(s) (second electroconductive ribs) 62 protruding from the inner wall of the cathode-side frame body 52, the current collector (second current collector) 72 held by the electroconductive ribs 62; the electroconductive elastic body (second elastic body) 82 held by the current collector 72; and the electroconductive rigid current collector 91 arranged between the elastic body 82 and the cathode 20. The cathode 20 is pushed by the elastic body 82 with the rigid current collector 91 therebetween toward the anode 40. That is, in the electrolysis vessel 400, the rigid current collector 91 is arranged in such a manner that the cathode 20 is sandwiched between the rigid current collector 91 and the separating membrane 10, and the cathode 20 is supported by the rigid current collector 91.

In the electrolysis vessel 400, the periphery of the anode 40 is held by the current collector 71, the elastic body 81, and/or the flange part 51b of the anode-side frame body 51. For holding the periphery of the anode 40 by the current collector 71, the elastic body 81, and/or the flange part 51b of the anode-side frame body 51, any known means such as welding, pinning, bolting, and turning in over the current collector 71 (that is, hanging the anode 40 on the periphery of the current collector 71 at a valley part of the anode 40 which is formed by turning in the periphery of the anode 40) may be employed without particular limitations.

In the electrolysis vessel 400, the periphery of the cathode 20 is held by the rigid current collector 91, the current collector 72, the elastic body 82, and/or the flange part 52b of the cathode-side frame body 52, and is preferably held by the rigid current collector 91. For holding the periphery of the cathode 20 by the rigid current collector 91, the current collector 72, the elastic body 82, and/or the flange part 52b of the cathode-side frame body 52, any known means such as welding, pinning, bolting, and turning in over the rigid current collector 91 or the current collector 72 (that is, hanging the cathode 20 on the periphery of the rigid current collector 91 or the periphery of the current collector 72 at a valley part of the cathode 20 which is formed by turning in the periphery of the cathode 20) may be employed without particular limitations.

In the electrolysis vessel 400, the separating membrane 10, the anode 40, and the first elastic body 81 are arranged in this order (that is, the anode 40 is arranged between the separating membrane 10 and the first elastic body 81), and the anode 40 is pushed by the first elastic body 81 toward the cathode 20 (that is, toward the separating membrane 10); and the separating membrane 10, the cathode 20, the rigid current collector 91, and the second elastic body 82 are arranged in this order (that is, the cathode 20 is arranged between the separating membrane 10 and the second elastic body 82; and the rigid current collector 91 is arranged between the cathode 20 and the second elastic body 82), and the cathode 20 is pushed by the second elastic body 82 with the rigid current collector 91 therebetween toward the anode 40 (that is, toward the separating membrane 10); thereby, the zero-gap configuration is realized. In the electrolysis vessel 400, the work of replacing the anode 40 that has reached its life span with the new anode 40 comprises: (1) separating the anode-side frame body 51 from the gasket 30; (2) separating the separating membrane 10 from the anode 40; (3) taking the anode 40 out of the anode chamber A; and (4) assembling the electrolysis vessel 400 with the new anode 40 instead of the taken-out anode 40. In the electrolysis vessel 400, it is easy to take the anode 40 out in the (3), and to assemble with the new anode 40 in the (4). Since the positions of the anode 40 and the cathode 20 are automatically adjusted by the first elastic body 81 and the second elastic body 82 in the assembled electrolysis vessel 400, complicated work as in a conventional zero-gab alkaline water electrolysis vessel (such as the work of adjusting the electroconductive ribs 913 and make the electroconductive ribs 913 the same height at their ends by griding or the like (see FIG. 1)) is not necessary for assembling with the new anode 40. Thus, the electrolysis vessel 400 also allows easy replacement of the anode 40. The electrolysis vessel 400 comprises the rigid current collector 91 between the cathode 20 and the second elastic body 82, which can cause the pressure at which the anode 40 and the cathode 20 are pushed toward the separating membrane 10 to be more uniform over the entire faces of both the electrodes, and thus, can cause the current density to be more uniform. The electrolysis vessel 400 comprises the rigid current collector 91 between the cathode 20 and the second elastic body 82, and thereby, can reduce deformation and abrasion of the separating membrane 10 which are caused by a pressure fluctuation in electrode chambers.

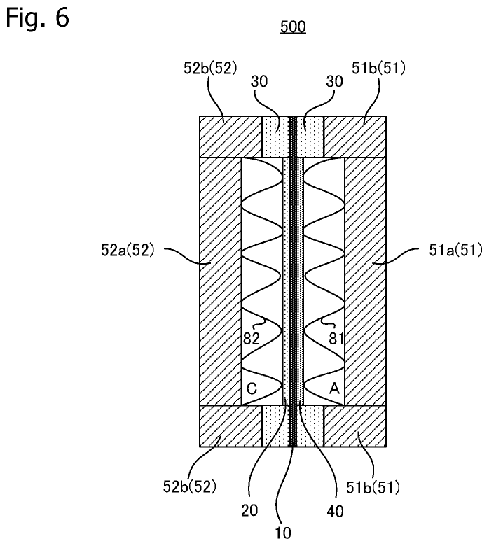

The alkaline water electrolysis vessels 100 to 400 each comprising the anode chamber comprising the electroconductive ribs 61, and the cathode chamber comprising the electroconductive ribs 62 have been described above concerning the present invention as an example. The present invention is not limited to this embodiment. For example, the alkaline water electrolysis vessel may comprise an anode chamber and a cathode chamber: only one of which comprises an electroconductive rib; or none of which comprise an electroconductive rib. FIG. 6 is a cross-sectional view schematically illustrating an alkaline water electrolysis vessel 500 according to such another embodiment (hereinafter may be referred to as “electrolysis element 500”). In FIG. 6, the elements already shown in FIGS. 2 to 5 are given the same reference signs as in FIGS. 2 to 5, and the description thereof may be omitted. As shown in FIG. 6, the electrolysis vessel 500 comprises: the electroconductive anode-side frame body 51 defining the anode chamber A; the electroconductive cathode-side frame body 52 defining the cathode chamber C; the ion-permeable separating membrane 10 being arranged between the anode-side frame body 51 and the cathode-side frame body 52, and separating the anode chamber A and the cathode chamber C; the gaskets 30, 30 being sandwiched by the anode-side frame body 51 and the cathode-side frame body 52 to be held therebetween, and holding the periphery of the separating membrane 10; the anode 40 being arranged in the anode chamber A without being held by any of the gaskets 30; and the cathode 20 being arranged in the cathode chamber C without being held by any of the gaskets 30. In the electrolysis vessel 500, the anode 40 is a flexible first porous plate. The cathode 20 may be a flexible second porous plate, and may be a rigid porous plate, and is preferably a rigid porous plate. The electrolysis vessel 500 comprises the electroconductive elastic body (first elastic body) 81 arranged in direct contact with the separating wall 51a and the anode 40 between the electroconductive separating wall 51a of the anode-side frame body 51 and the anode 40. The anode 40 is pushed by the elastic body 81 toward the cathode 20. The electrolysis vessel 500 also comprises the electroconductive elastic body (second elastic body) 82 arranged in direct contact with the separating wall 52a and the cathode 20 between the electroconductive separating wall 52a of the cathode-side frame body 52 and the cathode 20. The cathode 20 is pushed by the elastic body 82 toward the anode 40.

In the electrolysis vessel 500, the periphery of the anode 40 is held by the elastic body 81 and/or the anode-side frame body 51. For holding the periphery of the anode 40 by the elastic body 81 and/or the anode-side frame body 51, any known means such as welding, pinning, and bolting may be employed without particular limitations.

In the electrolysis vessel 500, the periphery of the cathode 20 is held by the elastic body 82 and/or the cathode-side frame body 52. For holding the periphery of the cathode 20 by the elastic body 82 and/or the cathode-side frame body 52, any known means such as welding, pinning, and bolting may be employed without particular limitations.

In the electrolysis vessel 500, the anode 40 is arranged between the separating membrane 10 and the first elastic body 81, and pushed by the first elastic body 81 toward the cathode 20; and the cathode 20 is arranged between the separating membrane 10 and the second elastic body 82, and pushed by the second elastic body 82 toward the anode 40; thereby, the zero-gap configuration is realized. In the electrolysis vessel 500, the work of replacing the anode 40 that has reached its life span with the new anode 40 comprises: (1) separating the anode-side frame body 51 from the gasket 30; (2) separating the separating membrane 10 from the anode 40; (3) taking the anode 40 out of the anode chamber A; and (4) assembling the electrolysis vessel 500 with the new anode 40 instead of the taken-out anode 40. In the electrolysis vessel 500, it is easy to take the anode 40 out in the (3), and to assemble with the new anode 40 in the (4). Since the positions of the anode 40 and the cathode 20 are automatically adjusted by the first elastic body 81 and the second elastic body 82 in the assembled electrolysis vessel 500, complicated work as in a conventional zero-gab alkaline water electrolysis vessel (such as the work of adjusting the electroconductive ribs 913 and make the electroconductive ribs 913 the same height at their ends by griding or the like (see FIG. 1)) is not necessary for assembling with the new anode 40. Thus, the electrolysis vessel 500 also allows easy replacement of the anode 40. Further, in the electrolysis vessel 500, the anode chamber A or the cathode chamber C comprises no electroconductive rib, which makes it possible to thinner each electrolytic cell, and thus to downsize the electrolysis vessel to increase the gas production per occupied site area. One or both of the anode chamber and the cathode chamber comprise(s) no electroconductive rib, which makes it possible to reduce the materials to constitute the electrolysis vessel, and the steps necessary for making the electrolysis vessel.

### REFERENCE SIGNS LIST

10 (ion-permeable) separating membrane

20, 21 cathode

30 gasket

40 anode

51 anode-side frame body

52 cathode-side frame body

51a, 52a (electroconductive) separating wall

51b, 52b flange part

61, 62 electroconductive rib

71, 72 current collector

81, 82 electroconductive elastic body

91 rigid current collector

900 conventional zero-gab alkaline water electrolysis vessel

910 electrode chamber unit

911 electroconductive separating wall

912 flange part

913, 914 electroconductive rib

920 ion-permeable separating membrane

930 gasket

940 anode

950 current collector

960 electroconductive elastic body

970 cathode

100, 200, 300, 400, 500, 900 alkaline water electrolysis vessel

A anode chamber

C cathode chamber

1. An alkaline water electrolysis vessel comprising:
an anode-side frame body defining an anode chamber;
a cathode-side frame body defining a cathode chamber;
an ion-permeable separating membrane being arranged between the anode-side frame body and the cathode-side frame body, and separating the anode chamber and the cathode chamber;
a gasket being sandwiched by the anode-side frame body and the cathode-side frame body to be held therebetween, and holding a periphery of the separating membrane;
an anode being arranged in the anode chamber without being held by the gasket;
a cathode being arranged in the cathode chamber without being held by the gasket; and
an electroconductive first elastic body arranged in the anode chamber,
wherein the anode is a flexible first porous plate; and
the anode is arranged between the separating membrane and the first elastic body, and is pushed by the first elastic body toward the cathode.

2. The electrolysis vessel according to claim 1,
the anode chamber comprising:
at least one first electroconductive rib protruding from an inner wall of the anode-side frame body; and
an electroconductive first current collector held by the first electroconductive rib, the first current collector supporting the first elastic body.

3. The electrolysis vessel according to claim 1 or 2,claim 1 further comprising:
an electroconductive first rigid current collector being arranged in contact with the anode,
the first rigid current collector being arranged between the anode and the first elastic body,
the first rigid current collector supporting the anode.

4. The electrolysis vessel according to claim 1, wherein the cathode is a rigid porous plate.

5. The electrolysis vessel according to claim 4,
the cathode chamber comprising:
at least one second electroconductive rib protruding from an inner wall of the cathode-side frame body,
the second electroconductive rib holding the cathode.

6. The electrolysis vessel according to claim 1, further comprising:
an electroconductive second elastic body arranged in the cathode chamber,
wherein the cathode is a flexible second porous plate; and
the cathode is arranged between the separating membrane and the second elastic body, and is pushed by the second elastic body toward the anode.

7. The electrolysis vessel according to claim 6,
the cathode chamber comprising:
at least one second electroconductive rib protruding from an inner wall of the cathode-side frame body; and
an electroconductive second current collector held by the second electroconductive rib,
the second current collector supporting the second elastic body.

8. The electrolysis vessel according to claim 6 further comprising:
an electroconductive second rigid current collector arranged in contact with the cathode,
the second rigid current collector being arranged between the cathode and the second elastic body,
the second rigid current collector supporting the cathode.

9. A method for replacement of an electrode of an alkaline water electrolysis vessel, the electrode being the anode of the alkaline water electrolysis vessel as defined in claim 1, the method comprising:
separating the anode-side frame body from the gasket;
separating the separating membrane from the anode;
taking the anode out of the anode chamber; and
assembling the alkaline water electrolysis vessel with a new anode instead of the anode taken out of the anode chamber.
